(19) United States
(12) Patent Application Publication
(10) Pub. No.: US 2024/0005406 A1
(43) Pub. Date: Jan. 4, 2024

(54) COMPUTER-IMPLEMENTED METHOD FOR EVALUATING AN INVESTMENT

(71) Applicant: Charalampos Oikonomidis, Athens Maroussi (GR)

(72) Inventor: Charalampos Oikonomidis, Athens Maroussi (GR)

(21) Appl. No.: 18/216,443

(22) Filed: Jun. 29, 2023

(30) Foreign Application Priority Data
Jul. 4, 2022 (GR) 20220100530

(51) Int. Cl. G06Q 40/06

(52) U.S. Cl. CPC G06Q 40/06

(57) ABSTRACT

A computer-implemented method is provided for financial analysis of a business entity, which involves loading input data from an external financial system or from manual entry or from any combination of those, and processing the input data to generate an initial set of primary entries that represent actual or forecasted financial incidents of the business entity. User interaction specifies data representing event type(s) and impact group(s). Each event type can be configured to define a link between primary entry(ies) and impact group(s) that distribute value of a primary entry to a referenced account over time. User interaction also specifies data representing exception codes and/or other criteria that are used to filter and transform at least the initial set of primary entries to generate and store primary entries and associated event types and impact groups based on the input data, which are used in financial value analysis that simulates the accounting books of the business entity (or part thereof) over time and determines a value of the financial incidents based on the simulation results.

### CROSS-REFERENCE TO RELATED APPLICATIONS

This application claims the benefit of Greek Patent Application 20200100530, filed Jul. 4, 2022, which is hereby incorporated by reference herein in its entirety.

### BACKGROUND

### Field

This invention relates broadly to computer-implemented financial analysis. More particularly, this invention relates to computer-implemented financial analysis methodologies for forecasting the profitability and the present value of an investment or entity over a predetermined future period of time as well as products and systems based thereon.

### State of the Art

In business, people often are confronted with forecasting and evaluating the value of an economic investment over a predetermined future period of time. For example, this analysis can be part of an investment plan or an annual budget for a business. Typically, the investment is represented by a series of forecasted financial incidents (e.g., actions and events) related to producing and/or selling goods or services over a predetermined future period of time. In order to evaluate the economic investment, a financial analyst (or a group of analysts) typically identifies and budgets financial incidents with respect to involved activities/departments (e.g., sales, production, expenses, purchases, payroll, collections, payments, etc.) over the predetermined future period of time. The incident values are used to calculate the profit and loss of the economic investment over the predetermined future period of time. A net present value result is calculated based upon individual cash flow collections and payments. This net present value result provides a single monetary figure that characterizes whether the expected monies collected over the predetermined future period of time will exceed the monies that are required to be paid out during the predetermined future period of time. This net present value result can be used as a gauge of the forecasted profitability/value of the investment over the predetermined future period of time.

Net present value is typically derived by modeling the investment as a sequence of positive and negative cash collections. The cash collections (positive values) and payments (negative values) are discounted into their equivalents as of the date of the beginning of the investment, after taking into consideration the appropriate discount rate. That is to say in simple terms, if an annual interest rate of 10% is assumed, then the possession on Jan. 1, 2006 of a sum of 100 EUR is equivalent to the future collection of a sum of 105 EUR after 6 months. With this method, all cash collections and payments are discounted into net present values, and in the end, they are added up. If the result is positive, the investment is profitable, while if it is negative, it is a loss maker.

The general mathematical formula that is used to discount a future cash flow to its net present value is the following: the future cash flow is divided with a factor, which is the number 1 plus the interest rate of interest bearing period, but only after the factor is raised to the v power, where v is the total number of interest bearing periods. The result of that division is the net present value of the cash flow.

Such prior art net present value methodologies have significant limitations. First, the implementations of the prior art net present value methodologies are exceptionally difficult for complex investments that produce a large number of financial incidents over time. Second, the prior art net present value methodologies are exceptionally inaccurate because situations with distinct differences are handled in the same manner. Moreover, there are often real and usual (even daily) situations for which the prior art net present value methodologies cannot give a suitable answer because of the inaccuracies built into the methods. Finally, the prior art net present value methodologies are incapable of generating a suitable answer for large investments because of the inaccuracies built into the methods.

The inventor of the present application has developed an improved computer-implemented methodology for forecasting and evaluating the value of an economic investment. Details of such methodology are described in the following patents: i) U.S. Pat. No. 7,668,768 (which claims priority to Greek Patent Application No. 20050100192, filed on Apr. 14, 2005) ii) U.S. Pat. No. 8,041,618 (which claims priority from Greek Patent Application 20070100319, filed on May 29, 2007); and iii) U.S. Pat. No. 8,229,822 (which claims priority from U.S. patent application Ser. No. 12/122,294, filed on May 16, 2008, now U.S. Pat. No. 8,041,618 and Greek Patent Application 20070100319, filed on May 29, 2007). The improved computer-implemented methodology determines the value of an economic investment by generating a simulation of the accounting books of a financial entity or business. The simulation results can be used as a tool in making decisions about activities such as funding, capital expenditure and investment in the business (or part of the business). The simulation is generated using a number of data structures, which include:
“Primary Entries”—data structures that represent financial incidents with respect to involved activities/departments (e.g., sales, production, expenses, purchases, payroll, collections, payments, etc.) over a predetermined period of time. The predetermined period of time can extend into the future for forecasting performance. The predetermined period of time can also extend into the past to take into account past performance or actual or realized value. The primary entries can represent forecasted sales, forecasted expenses (e.g., salaries, advertising and other marketing costs, rent, utilities, lawyer's fees, other expenses), fixed asset values, depreciation of fixed assets or other forecasted financial incidents. The primary entries can also represent realized (past) sales, realized (past) expenses (e.g., salaries, advertising and other marketing costs, rent, utilities, lawyer's fees, other expenses), realized asset values, depreciation of fixed assets or other realized (past) financial incidents.
“Impact Groups”—data structures that dictate allocation of the value of an associated primary entry to one or more accounts over time; such accounts are part of the simulated accounting books of the financial entity or business.
“Event Types”—data structures that identify the type of one or more primary entries associated therewith and that link or associate primary entry(ies) to one or more impact groups.
“Variation Factors”—data structures that can be used in conjunction with primary entries and/or impacts groups to convert numerical values through the application of certain rules; the variation factors can be used for investigating possible scenarios and/or situations (e.g., what-if scenarios), and/or the composition of the calculation method of some numerical value, etc.
“Calculated Cash Flows”—data structures that are used to handle financial incidents that are conditional in nature, and whose occurrence depends on the satisfaction of a certain criterion (e.g. VAT payment, interest income, interest expense, income tax, etc.).
“Rules to Find Date”—data structures that are used to convert one date to another data (such as to account for weekends or bank holidays).

Operations that define and configure these data structures can be complex and time consuming, particularly for analysis that involves a large number of financial incidents over time. For example, existing financial software systems (such as ERP systems and/or budgeting modules) can store information representing a large number of actual or forecasted financial incidents of a business entity over time. Extracting the relevant information from the financial software system and defining and configuring the data structures to represent such relevant information and simulate the accounting books of a financial entity or business can be a difficult and time-consuming task. These limitations can hinder acceptance and perceived value of the improved computer-implemented methodology.

### SUMMARY

It is therefore an object of the invention to provide a computer-implemented method for financial analysis of a business entity, which involves loading input data from an external financial system and processing the input data to generate an initial set of primary entries that represent actual or forecasted financial incidents of the business entity. User interaction specifies data representing one or more event types and one or more impact groups. Each event type can be configured to define a link between one or more primary entries and one or more impact groups. Each impact group is configured to distribute value of an associated primary entry (or percentage thereof) to a referenced account over time. User interaction also specifies data representing one or more exception codes that filter and transform at least the initial set of primary entries to generate and store primary entries and associated event types and impact groups based on the input data. The primary entries and associated event types and impact groups that result from the transformation and filtering are used in financial value analysis that simulates the accounting books of the business entity (or part thereof) over time and determines a value of the financial incidents based on the simulation results.

In embodiments, the user can use the value of the financial incidents of the business entity as a tool in making decisions about activities, such as funding, capital expenditure or investment in the business entity (or part thereof).

In embodiments, the at least one exception code can be configured by user interaction with at least one graphical user interface presented to the user.

In embodiments, the at least one exception code can be used as part of a software-implemented data handler that employs text data and/or date data as part of matching criteria, wherein the matching criteria is used to selectively apply exception processing that dynamically filters and transforms data to generate and store primary entries and associated impact groups and optional CCF calculations based on the input data.

In embodiments, the at least one exception code can be configured to generate a first set of primary entries and associated impact groups and optional CCF calculations that are based on the input data and relevant to the financial value analysis. And the at least one exception code is further configured to generate a second set of primary entries and associated impact groups and optional CCF calculations that are based on the input data but excluded or irrelevant to the financial value analysis.

In embodiments, impact groups and associated CCF calculations that result from the filtering and transformation can be used in financial value analysis that generate analytical lines that represent debits or credits to specific accounts over time, where the analytical lines are grouped together to create the accounts that simulate the accounting books of the business entity (or part thereof) over time.

In embodiments, the at least one exception code can include at least one event type exception code that filters and transforms at least one primary entry from a source event type to a target event type. The at least one event type exception code can be configured by the user to perform exception processing that selectively applies the target event type of the event type exception driver to a primary entry that matches matching criteria of the event type exception driver when the primary entry is associated with the source event type of the event type exception driver.

Additionally or alternatively, the at least one exception code can include at least one CCF exception code that filters and transforms a source CCF identifier to a target CCF identifier. The at least one CCF exception code can be configured by the user to perform exception processing that selectively applies target CCF calculations referenced by the CCF exception code to an impact group that matches the matching criteria of the CCF exception code when the impact group refers to the source CCF calculations referenced by the CCF exception code.

Additionally or alternatively, the at least one exception code can include at least one bank account exception code that filters and transforms a source bank account identifier to a target bank account identifier. The at least one bank account exception code can be configured by the user to perform exception processing that selectively applies a target bank account referenced by the bank account exception code to an impact group that matches the matching criteria of the bank account exception code when the impact group refers to a source bank account referenced by the bank account exception code.

Additionally or alternatively, the at least one exception code can include at least one value of number exception code that filters and transforms a number value to a target number value. The at least one value of a number exception code can be configured to selectively transform the value of a variation factor that is part of a primary entry or impact group. The transformation of the variation factor can be used to investigate possible scenarios and/or situations (e.g., what-if scenarios) in conjunction with the financial value analysis.

In other aspects, a program storage device readable by a machine can embody a program of instructions executable by the machine to the method steps for financial analysis of a business entity as described herein.

Additional objects and advantages of the invention will become apparent to those skilled in the art upon reference to the detailed description taken in conjunction with the provided figures.

### BRIEF DESCRIPTION OF THE DRAWINGS

FIGS. 1A-1E, collectively, is a flow chart of a computer-implemented methodology for financial analysis of a business entity (or part thereof) in accordance with the present disclosure.

FIG. 2 illustrates an example graphical user interface that enables a user to view (and possibly edit) an initial set of primary entries generated from the data output (exported) from one or more financial accounting systems in accordance with the present disclosure.

FIG. 3A illustrates an example graphical user interface that enables a user to specify (create or edit) data representing one or more companies in accordance with the present disclosure.

FIG. 3B illustrates an example graphical user interface that enables a user to specify (create or edit) data representing one or more bank accounts in accordance with the present disclosure.

FIG. 3C illustrates an example graphical user interface that enables a user to specify (create or edit) data representing one or more items (such as goods, services, material, assets, etc.) in accordance with the present disclosure.

FIG. 4 illustrates an example graphical user interface that enables a user to specify (create or edit) data representing a primary entry in accordance with the present disclosure.

FIG. 5 illustrates an example graphical user interface that enables a user to specify (create or edit) data representing an impact group in accordance with the present disclosure.

FIG. 6 illustrates an example graphical user interface that enables a user to specify (create or edit) data representing a calculated cash flow (CCF) in accordance with the present disclosure.

FIG. 7 illustrates an example graphical user interface that enables a user to specify (create or edit) data representing a CCF group in accordance with the present disclosure.

FIG. 8 illustrates an example graphical user interface that enables a user to specify (create or edit) data representing an event type in accordance with the present disclosure.

FIG. 9 illustrates an example graphical user interface that enables a user to specify (create or edit) data representing an event type exception code in accordance with the present disclosure.

FIG. 10 illustrates an example graphical user interface that enables a user to specify (create or edit) data representing a primary entry, including specifying the event type associated with a particular primary entry.

FIG. 11 illustrates an example graphical user interface that enables a user to specify (create or edit) data representing a bank account exception code in accordance with the present disclosure.

FIG. 12 illustrates an example graphical user interface that enables a user to specify (create or edit) data representing a CCF exception code in accordance with the present disclosure.

FIG. 13 illustrates an example graphical user interface that enables a user to specify (create or edit) data representing a value of a number exception codes in accordance with the present disclosure.

FIG. 14 illustrates an example graphical user interface that enables a user to create and/or configure a variation factor in accordance with the present disclosure.

FIG. 15 is a flow chart of exception processing methodology that associates user-defined priorities with exception codes and uses the priorities to handle instances where the matching criteria for more than one exception codes is satisfied by a data item in accord with the present disclosure.

FIG. 16 is a schematic representation of the relation of primary entries, event type, impacts groups and analytical lines in accord with the present disclosure.

FIG. 17 is an exemplary representation of the relation of a primary entry, its impact group(s), and analytical lines derived therefrom in accordance with the present disclosure.

FIG. 18 is a functional block diagram of an exemplary computer processing system, which can embody the computer-implemented method of the present disclosure.

### DETAILED DESCRIPTION OF THE PREFERRED EMBODIMENTS

The present disclosure describes computer-implemented methods that ingest input data related to actual and/or forecasted financial incidents of a business entity (or part of a business entity) over time and filters and transforms data to generate and store primary entries and associated event types and impact groups based on the input data. The primary entries and the associated event types and impact groups that result from the filtering and transformation can be processed by financial value analysis that generates a simulation of the accounting books of the financial entity or business (or part thereof) over time and determines a value of the actual and/or forecasted financial incidents based on the simulation results. The value derived from the simulation results can be used as a tool in making decisions about activities such as funding, capital expenditure and investment in the entity or business (or part thereof). The data filtering and transformation is configured by exception codes and/or other relevant info that are configured by user interaction with corresponding graphical user interfaces. The exception codes are used as part of software-implemented data handlers that employ text data and/or date data as matching criteria. The matching criteria are used to selectively apply exception processing that dynamically filters and transforms data to generate and store primary entries and associated impact groups and optional CCF calculations based on the input data. The text data and/or the date data of the exception codes can be configured by user interaction with the graphical user interfaces. The exception codes can be configured to transform and/or generate a first set of primary entries and associated impact groups and optional CCF calculations that are based on the input data and relevant to the financial value analysis (and thus used in the financial value analysis). The exception codes can also be configured to transform and/or generate a second set of primary entries that are based on the input data but excluded or irrelevant to the financial value analysis (and thus not used in the financial value analysis).

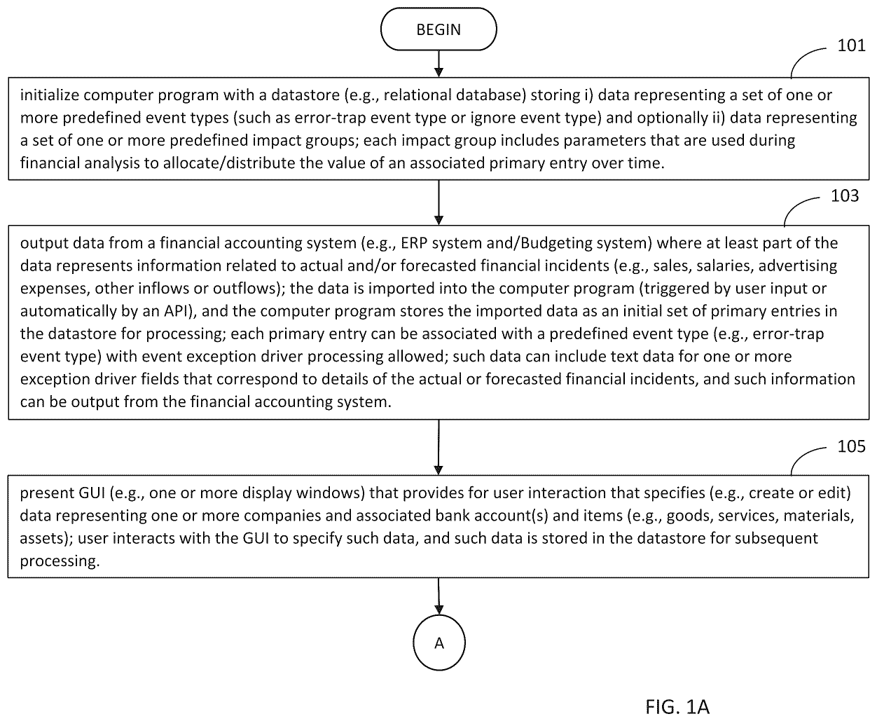

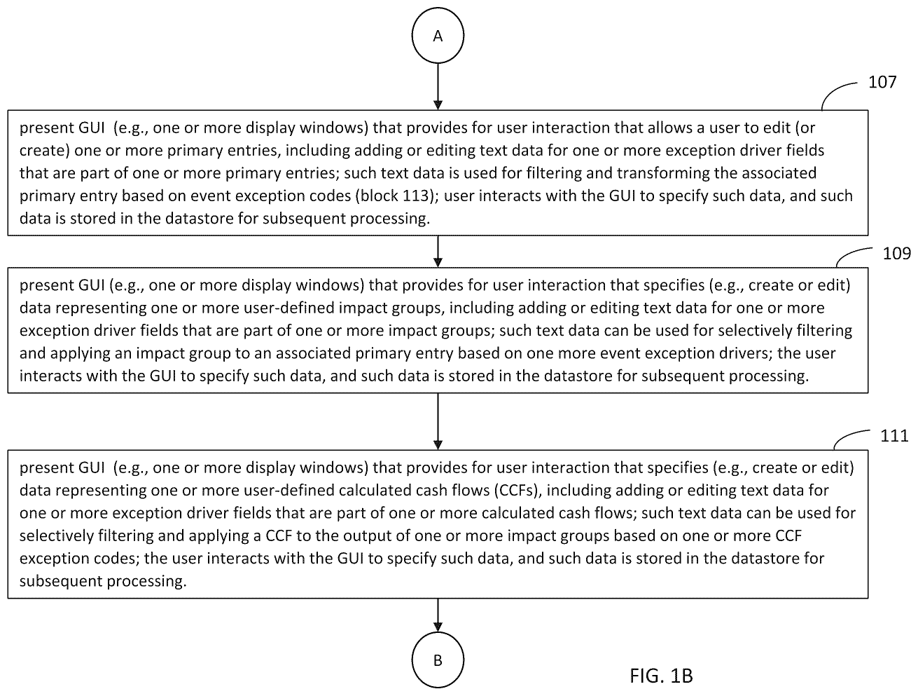

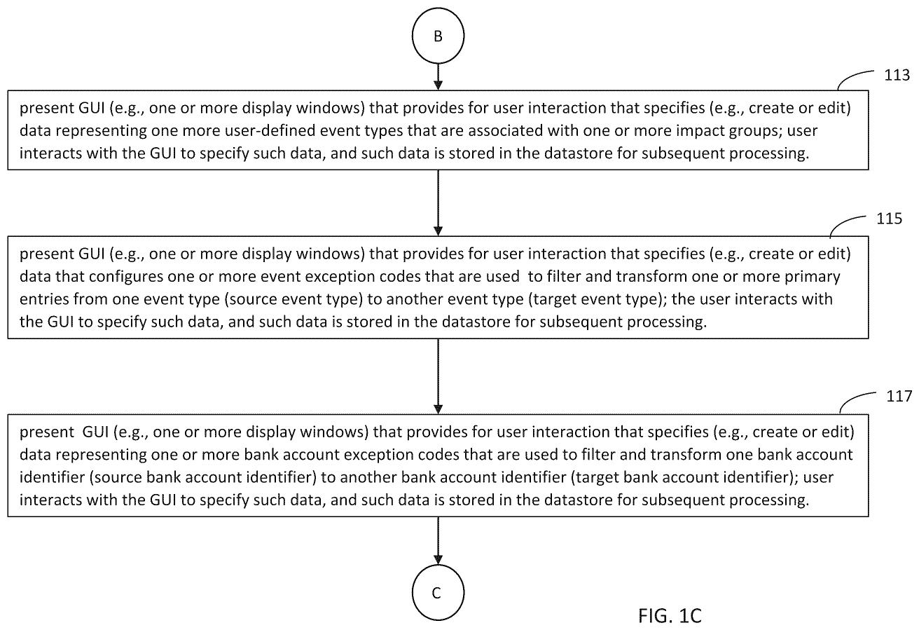

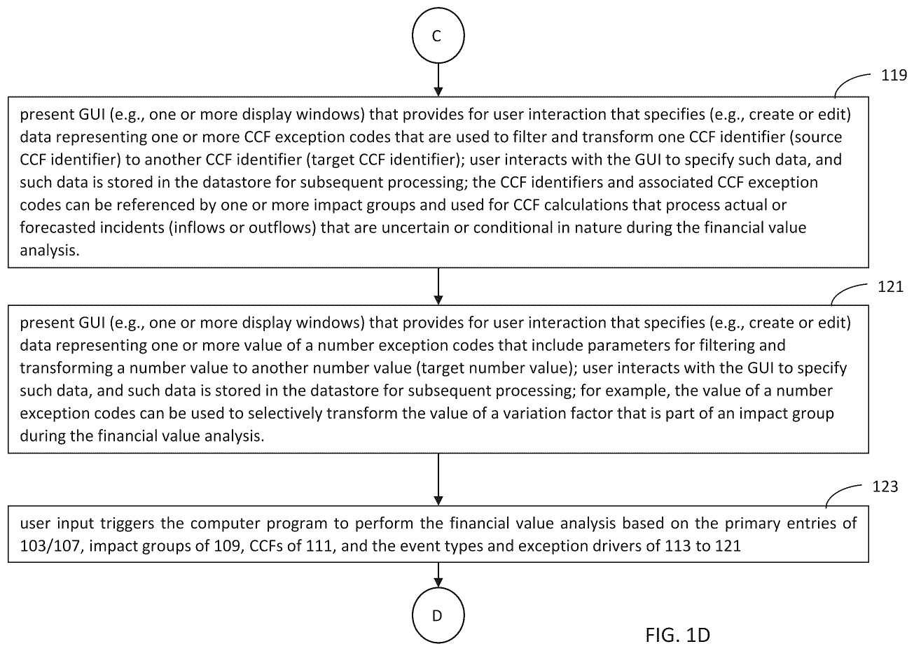

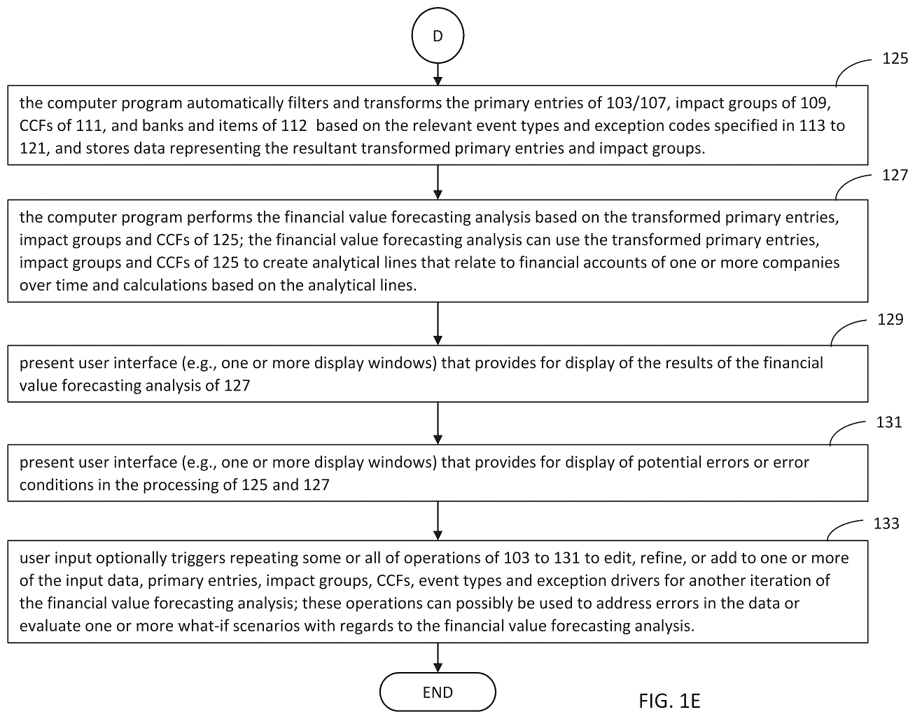

FIGS. 1A to 1E illustrate an example workflow that embodies computer-implemented methods according to the present disclosure.

The workflow begins in block 101 wherein a computer program is initialized with a datastore (e.g., a relational database) storing i) data representing a set of one or more predefined event types (such as error-trap event type or ignore event type) and optionally ii) data representing a set of one or more predefined impact groups. Each predefined impact group includes parameters that are used during the financial value analysis (block 123) to dictate allocation of the value of an associated primary entry to one or more accounts over time. Such accounts are part of the simulated accounting books of the financial entity or business. The parameters of the impact groups can refer to one or more particular accounts. The parameters of the impact groups can also possibly refer to CCFs related to particular accounts to address financial incidents that are conditional in nature. Examples of such conditional financial incidents include payment of VAT taxes collected as VAT taxes will only be payable if there is a credit balance in the appropriate account. In another example, interest expense payments are conditional in nature because they are payable only when there is a credit balance. In yet another example, interest income is conditional in nature because it is payable only when there is a debit balance. In yet another example, tax payments are conditional in nature and need to be calculated based on appropriate criteria (e.g., bank account balances). In another example, taxable income calculations are conditional in nature and need to be calculated based on other calculations (e.g., gross profits, deductible expenses, deductible tax payments, deductible interest credits, and deductible interest payments. In yet another example, net income and its allocation are conditional in nature and need to be calculated based on other calculations (e.g., taxable income, non-deductible expenses, certain interest credits and payments, non-deductible tax payments and income tax payments). In other examples, inventory and other cost of goods calculations are conditional in nature. Separate labels or codes may be used to refer to the CCFs for the different types of conditional financial incidents. The value and date and possibly other parameters of a primary entry can be used in conjunction with the parameters of the impact group and optional CCF associated therewith to derive analytical lines for the corresponding accounts, and the analytical lines can be grouped into the appropriate accounts (targets of impact).

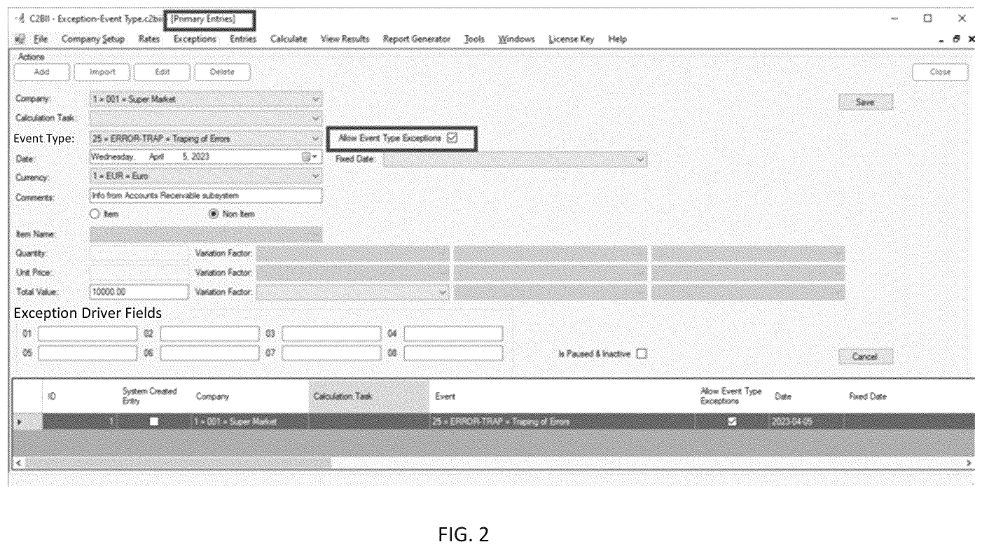

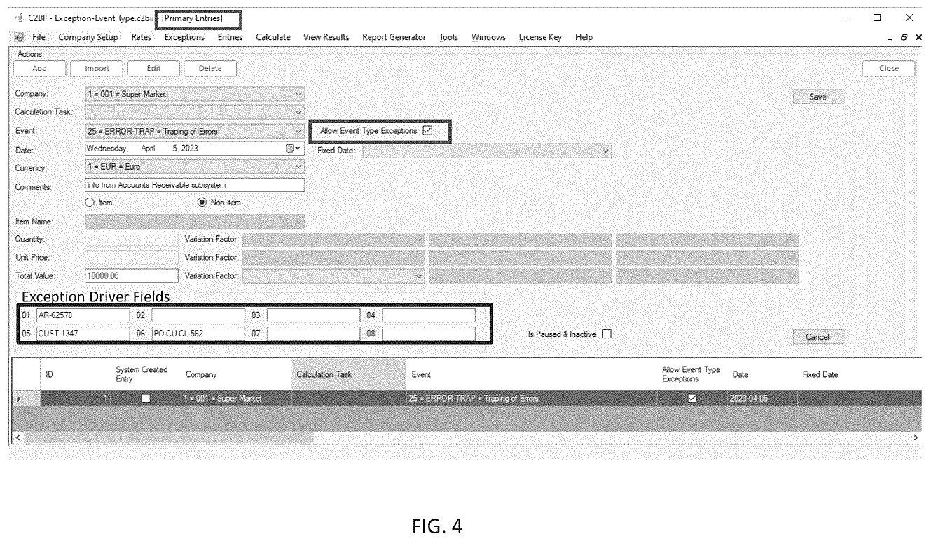

In block 103, data is output (exported) from one or more financial accounting systems (e.g., ERP system and/or budgeting system etc.). At least part of the exported data represents information related to actual and/or forecasted financial incidents (e.g., sales, salaries, advertising expenses, other inflows or outflows) of a business entity (or part of a business entity) over time. The data is imported into the computer program. The import of the data can involve manual user input (e.g., user input imports a data file, such as a CSV file or Excel file) or automatic operations (e.g., data ingestion through a data exchange API). The computer program stores the data as an initial set of primary entries in the datastore for processing. The user can be presented with a graphical user interface (e.g., one or more display windows) that enables the user to view (and edit) the initial set of primary entries (FIG. 2). Each primary entry can be associated with a predefined event type (e.g., error-trap event type) with event exception driver processing allowed. The imported data can include text data for one or more exception driver fields. The text data can relate to details of the actual or forecasted incidents, and such information can be output directly from the financial accounting system or specified by user input (block 107). Such text data can be saved in the primary entry's Exception driver fields (FIG. 4), so that they can be evaluated and compared to the matching criteria of one or more event exception codes (as configured in block 115) for selectively filtering and transforming the associated primary entry based on one or more event exception codes as described herein.

In block 105, a user is presented with a graphical user interface (e.g., one or more display windows) that provides for user interaction that specifies (e.g., create or edit) data representing one or more companies and associated bank account(s) and items (such as goods, services, materials, assets, etc.). The user interacts with the graphical user interface to specify such data, and such data is stored in the datastore for subsequent processing.

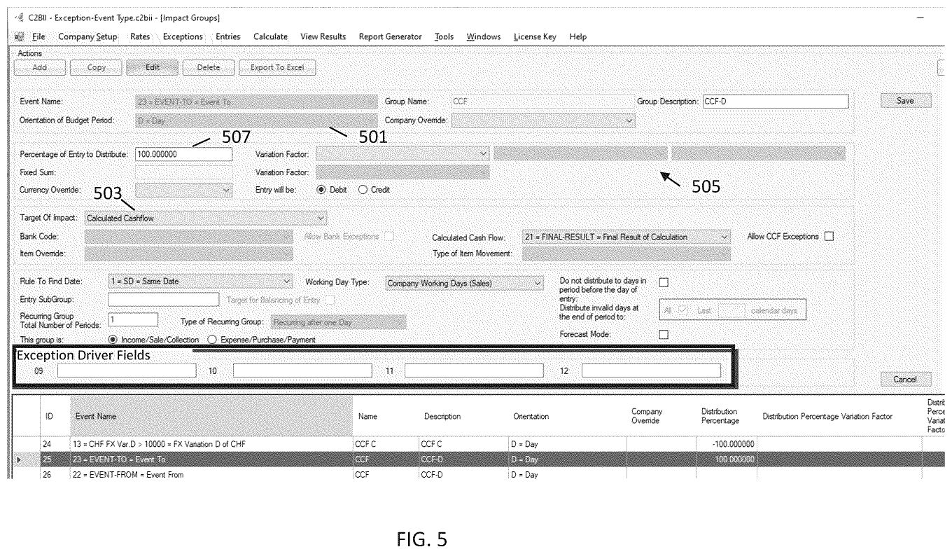

In block 107, the user is presented with a graphical user interface (e.g., one or more display windows) that provides for user interaction that allows a user to edit (or create) one or more primary entries, including adding or editing text data for one or more exception driver fields that are part of one or more primary entries. Such text data can be evaluated and compared to the matching criteria of one or more event exception codes (as configured in block 115) for selectively filtering and transforming the target of impact of the impact group (FIG. 5) of the event type of the associated primary entry based on event exception drivers and codes as described herein. The user interacts with the graphical user interface to specify such data, and such data is stored in the datastore for subsequent processing.

In block 109, the user is presented with a graphical user interface (e.g., one or more display windows) that provides for user interaction that specifies (e.g., create or edit) data representing one or more user-defined impact groups, including adding or editing text data for one or more exception driver fields that are part of one or more impact groups. Similar to the predefined impact groups (block 101), the user-defined impact group(s) includes parameters that are used during the financial value analysis (block 123) to dictate allocation of the value of an associated primary entry to one or more accounts over time. The text data of the exception driver field(s) that are part a user-defined impact group can be evaluated and compared to the matching criteria of one or more event exception codes (as configured in block 115) for selectively filtering and applying the impact group to an associated primary entry based on one more event exception drivers as described herein. The user interacts with the graphical user interface to specify such data, and such data is stored in the datastore for subsequent processing.

In block 111, the user is presented with a graphical user interface (e.g., one or more display windows) that provides for user interaction that specifies (e.g., create or edit) data representing one or more user-defined calculated cash flows (CCFs), including adding or editing text data for one or more exception driver fields that are part of one or more CCFs. Each CCF includes parameters that are used to handle financial incidents that are conditional in nature, and whose occurrence depends on the satisfaction of a certain criterion (e.g., VAT payment, interest income, interest expense, income tax, etc.). The text data of the exception driver field(s) that are part a user-defined CCF can be evaluated and compared to the matching criteria of one or more event exception codes (as configured in block 115) for selectively filtering and applying the CCF to the output of one or more impact groups based on one more CCF exception codes as described herein. The user interacts with the graphical user interface to specify such data, and such data is stored in the datastore for subsequent processing.

In block 113, the user is presented with a graphical user interface (e.g., one or more display windows) that provides for user interaction that specifies (e.g., create or edit) data representing one more user-defined event types. The user interacts with the graphical user interface to specify such data, and such data is stored in the datastore for subsequent processing.

In block 115, the user is presented with a graphical user interface (e.g., one or more display windows) that provides for user interaction that specifies (e.g., create or edit) data for configuring one or more event exception codes that are used to filter and transform one or more primary entries from one event type (source event type) to another event type (target event type). The user interacts with the graphical user interface to specify such data, and such data is stored in the datastore for subsequent processing.

The primary entries and impact groups can be associated with (or mapped to) the event types (blocks 101 and 113) under user control. The source and target event types of the event exception codes (block 115) can also be associated with (or mapped to) event types (blocks 101 and 113) under user control. This association/mapping provides the user with flexibility in associating or linking primary entries to impact groups for use in the financial value analysis. Furthermore, this association/mapping enables a user-defined event exception code to be used to selectively filter and apply an impact group that is configured to distribute the actual or forecasted incidents of the primary entries that match the user-defined event exception code as part of the financial value analysis. The distribution flows as debits or credits to predefined accounts as dictated by the associated impact group associated with the matching primary entry.

In block 117, the user is presented with a graphical user interface (e.g., one or more display windows) that provides for user interaction that specifies (e.g., create or edit) data for configuring one or more bank account exception codes that are used to filter and transform one bank account identifier (source bank account identifier) to another bank account identifier (target bank account identifier). The user interacts with the graphical user interface to specify such data, and such data is stored in the datastore for subsequent processing. The transformation from one bank account identifier (source bank account identifier) to another bank account identifier (target bank account identifier identifier) can be used to selectively apply the target bank account identifier (in place of the source bank account identifier) as the output of an impact group during the financial value analysis.

In block 119, the user is presented with a graphical user interface (e.g., one or more display windows) that provides for user interaction that specifies (e.g., create or edit) data for configuring one or more CCF exception codes that are used to filter and transform one CCF identifier (source CCF identifier) to another CCF identifier (target CCF identifier). The user interacts with the graphical user interface to specify such data, and such data is stored in the datastore for subsequent processing. The CCF identifiers and associated CCF exception codes can be referenced by one or more impact groups and used for CCF calculations that process actual or forecasted incidents that are uncertain or conditional in nature during the financial value analysis. The transformation from one CCF identifier (source CCF identifier) to another CCF identifier (target CCF identifier) can be used to selectively apply the CCF operations of the target CCF identifier (in place of the source CCF identifier) to the output of an impact group during the financial value analysis.

In block 121, the user is presented with a graphical user interface (e.g., one or more display windows) that provides for user interaction that specifies (e.g., create or edit) data representing one or more value of a number exception codes that include parameters for filtering and transforming any number value to another number value (target number value). The user interacts with the graphical user interface to specify such data, and such data is stored in the datastore for subsequent processing. For example, the value of a number exception code can be used to selectively transform the value of a variation factor that is part of a primary entry or impact group during the financial value analysis. The transformation of the variation factors can be used for investigating possible scenarios and/or situations (e.g., what-if scenarios) in conjunction with the financial value analysis, and/or the composition of the calculation method of some numerical value in conjunction with the financial value analysis.

In block 123, input by the user triggers the computer program to perform the financial value analysis based on the primary entries of 103/107, the impact groups of 101/109, the CCFs of 111, and the event types and exception codes of 113 to 121. As part of block 123, the exception codes of 115 to 121 can be used to filter and transform primary entries and associated impact groups and optional CCF calculations, or parts thereof. The association or linkage between primary entries and/or impact groups and the applicable event exception codes can be provided by corresponding entry type. The association between primary entries and/or impact groups and applicable bank account exception codes can be provided by corresponding bank identifier. The association between primary entries and/or impact groups and the applicable CCF exception codes can be provided by corresponding CCF identifier. The association between primary entries and/or impact groups and/or CCF calculations and the applicable value of a number exception code can be provided by a corresponding number value. The exception codes are used in software-implemented data handlers that employ text data and/or date data and/or other type of data as matching criteria for selectively applying exception processing to the primary entries, impact groups, or optional CCF calculations, or parts thereof. The exception processing can involve data filtering and possibly data transformation operations as described herein. The primary entries and impact groups and optional CCF calculations that result from the exception processing can be used in the financial value analysis to generate a simulation of the accounting books of the financial entity or business (or part thereof) over time. The simulation results can be processed to determine a value of the actual and/or forecasted financial incidents based on the simulation results. The value derived from the simulation results can be used as a tool in making decisions about activities such as funding, capital expenditure and investment in the entity or business (or part thereof).

In embodiment, the graphical user interfaces of the workflow of FIGS. 1A to 1E can be implemented by a number of tabbed display windows as commonly used in computer software.

FIG. 2 illustrates an example graphical user interface (display window) that can be presented as part of block 103 of the workflow of FIGS. 1A to 1E to enable a user to view (and possibly edit) the initial set of primary entries generated from the data output (exported) from one or more financial accounting systems. One example primary entry of the initial set of primary entries is shown, which includes a company field that includes a company identifier, a calculation task field that links a set of predefined operations for a user-defined time period to the company (or group of companies) for use in the financial value analysis of block 123, an event type field that specifies an event type that is associated with the primary entry (in this case, a default error trap event type), an exception code processing allowed check box that can be selected to indicate that exception code processing is allowed for the primary entry (or cleared to indicate that that exception driver processing is not allowed for the primary entry), one or more date fields and value information (or quantity/unit price information) that represent the date and value of financial incident as represented by the primary entry, one or more optional variation factors that can be applied to value information of the primary entry, and text data for one or more exception driver fields (for example, eight exception driver fields labeled 01-08 as shown). The text data stored in the exception driver fields can relate to details of the actual or forecasted incidents, and such information can be output directly from the financial accounting system or specified by user input (block 107). Such text data can be evaluated and compared to text-based matching criteria of one or more event exception codes (as configured in block 115) for selectively filtering and transforming the associated primary entry based on one or more event exception codes as described herein.

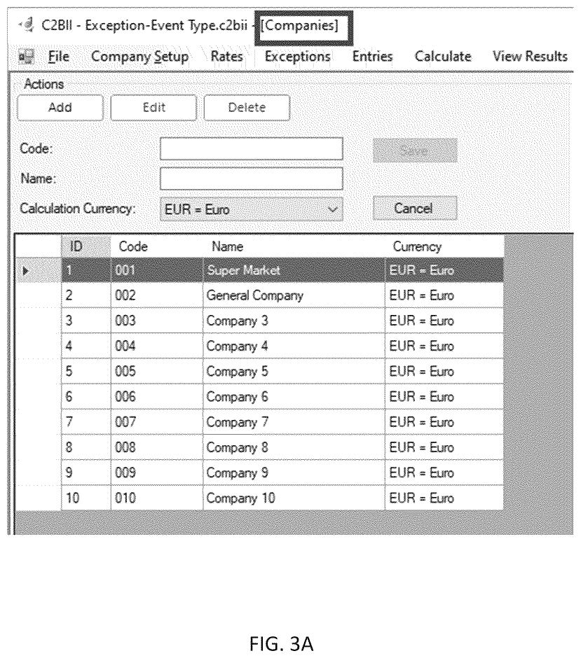

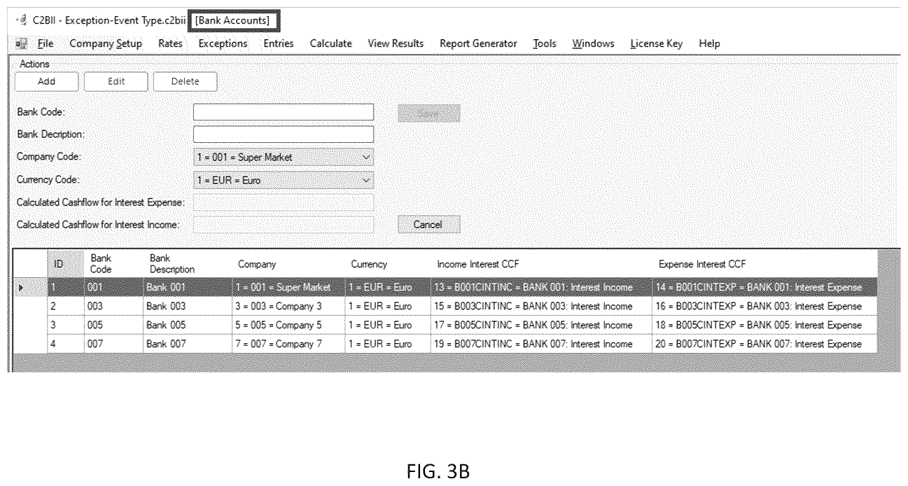

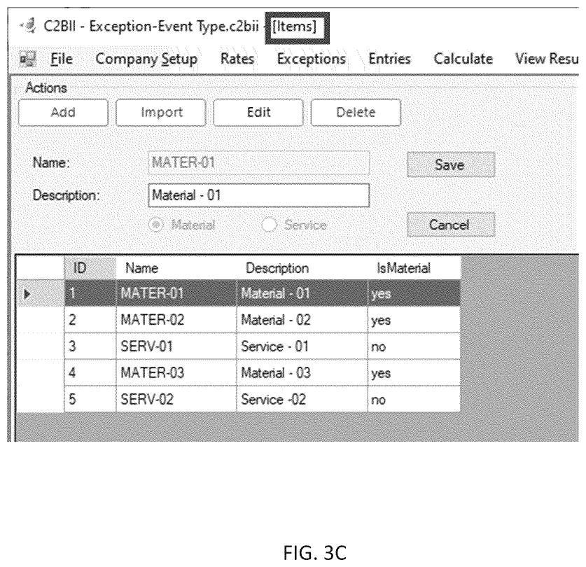

FIG. 3A illustrates an example graphical user interface (display window) that can be presented as part of block 105 of the workflow of FIGS. 1A to 1E to enable a user to specify (create or edit) data representing one or more companies.

FIG. 3B illustrates an example graphical user interface (display window) that can be presented as part of block 105 of the workflow of FIGS. 1A to 1E to enable a user to specify (create or edit) data representing one or more bank accounts.

FIG. 3C illustrates an example graphical user interface (display window) that can be presented as part of block 105 of the workflow of FIGS. 1A to 1E to enable a user to specify (create or edit) data representing one or more items (such as goods, services, material, assets, etc.).

FIG. 4 illustrates an example graphical user interface (display window) that can be presented as part of block 107 of the workflow of FIGS. 1A to 1E to enable a user to edit a primary entry to add text in one or more exception driver field(s). In this example, one example primary entry is shown where the user has added text data into the exception driver field(s) labeled “01”, “05” and “06” for the primary entry.

FIG. 5 illustrates an example graphical user interface (display window) that can be presented as part of block 109 of the workflow of FIGS. 1A to 1E to enable a user to specify (e.g., create or edit) data representing one or more user-defined impact groups. One example user-defined impact group is shown, which includes an orientation period (e.g., year, month, week, quarter, etc.) defined by user interaction with pull-down menu 501, an account defined by user interaction with pull-down menu 503, where a choice is made by the user, about the nature of the “Target of Impact” that will be affected (and accordingly, on that basis, the program allows the choosing of a code, either from “Bank Code” or from “Calculated Cash Flow Code” or from “Item Code”), and a set of variation factors defined by user interaction with input boxes or pull-down menu 505. The date of the primary entry associated with the impact group (by event type) and the orientation period (501) of the impact group defines a time period over which the value of the associated primary entry is to be allocated. The variation factors (505) of the impact group dictate the allocation of the value of the associated primary entry for the account (503) over this time period. The data for the impact group can also include a percentage value specified by user interaction input box 507. This percentage value dictates a percentage of the value of the associated primary entry to allocate over the account (503) of the impact group in accordance with the variation factors (505) and the time period defined by the date of the associated primary entry and the orientation period (501).

The data for the impact group can include other user-specified data items, such as:
an entry type (e.g., debit or credit type which dictates whether the analytical lines for the primary entry and impact group will be debit entries or credit entries for the account of the impact group);
parameters for CCF calculations for the impact group, including a user-specified reference to a CCF;
parameters for rules-to-find-date calculations for the impact group, including a user-specified reference to a rules to find date; and
an impact group type (e.g., income/sale type or expense/purchase type—these types can be used to select or derive an appropriate currency exchange rate if the monies are to be paid or collected in a foreign currency).

The analytical lines for the accounts as generated by the impact groups and associated CCFs represent debits or credits to specific accounts over time. The analytical lines can be grouped together to create the accounts that simulate the accounting books of the company or part thereof over time. The accounts can include, for example, bank accounts, tax payments, inventory items, expenses, profit and loss, etc.

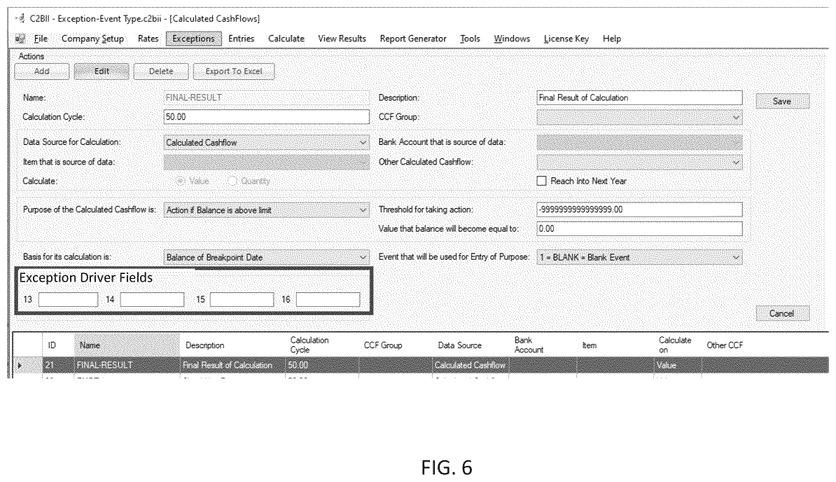

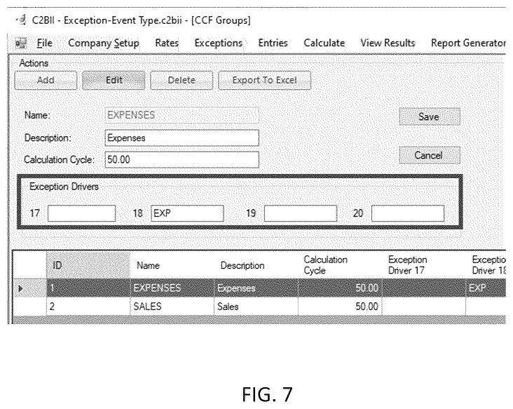

The data representing the impact group also include text data for one or more exception driver fields (for example, four exception driver fields labeled 09-12 as shown). The text data stored in the exception driver fields can relate to details of the related actual or forecasted incidents. The text data of the exception driver field(s) that are part a user-defined impact group can be evaluated and compared to text-based matching criteria of one or more exception codes for selectively filtering and transforming the impact group's “Target of Impact” (either Bank of CCF or Item) based on one or more exception driver fields (exception driver fields 01-08 in FIG. 4, coming from the Primary Entry, plus exception driver fields 09-12 in FIG. 5, coming from the specific impact group that is under processing) and the exception codes as described herein. Plus, if the “Target of Impact” of the impact group is a CCF code, then the exception driver fields 13-16 (FIG. 6) can also be included with the previous mentioned twelve (12) exception driver fields. And if that CCF code has been defined as to be included in a CCF Group (FIGS. 6 and 7), then the exception driver fields 17-20 can also be included to the previous mentioned sixteen (16) exception drivers.

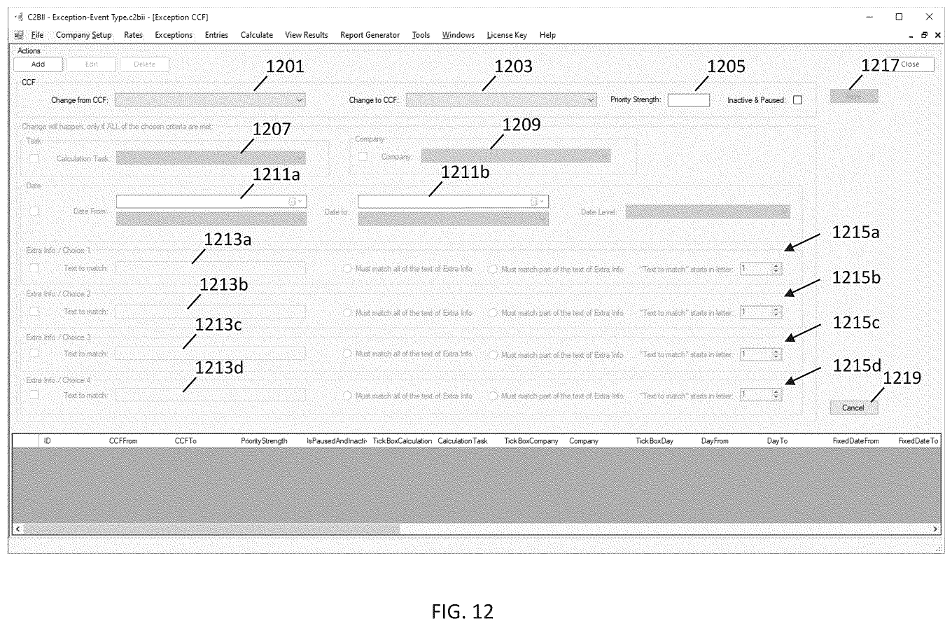

FIG. 6 illustrates an example graphical user interface (display window) that can be presented as part of block 111 of the workflow of FIGS. 1A to 1E to enable a user to specify (e.g., create or edit) data representing one or more user-defined calculated cash flows (CCFs). One example user-defined CCF is shown, which includes text data for one or more exception driver fields (for example, four exception driver fields labeled 13-16 as shown). The text data stored in the exception driver fields can relate to details of the related actual or forecasted incidents. The text data of the exception driver field(s) that are part the user-defined CCF can be evaluated and compared to text-based matching criteria of one or more CCF exception codes for selectively applying a CCF to the output of one or more impact groups based on one more one or more CCF exception drivers as described herein (block 119, FIG. 12) and in paragraph 0065.

FIG. 7 illustrates an example graphical user interface (display window) that can be presented as part of block 111 of the workflow of FIGS. 1A to 1E to enable a user to specify (e.g., create or edit) data representing one or more user-defined CCF groups. One example user-defined CCF group is shown, which includes text data for one or more exception driver fields (for example, four exception driver fields labeled 17-20 as shown). The text data stored in the exception driver fields can relate to details of the related actual or forecasted incidents. The text data of the exception driver field(s) that are part the user-defined CCF groups can be evaluated and compared to text-based matching criteria of one or more CCF exception codes (as configured in block 119) for selectively filtering and applying the CCFs that belong to the CCF group to output of one or more impact groups based on one more CCF exception codes as described herein. A CCF group provides a mechanism of grouping together a number of CCFs. For example, all Sales CCFs, or all Expenses CCFs, etc. The purpose or the grouping, is to be able to process the CCFs of the group together and simultaneously. For example, consider that thirty (30) CCFs related to sales are grouped together, under one CCF group. So, instead of needing to define thirty (30) breakpoints for the moving of their balances to the “Gross Profit Account”, the financial value analysis can be configured to employ one breakpoint for the CCF group where all the CCFs that are part of that CCF group will be processed using the breakpoint date for the CCF group.

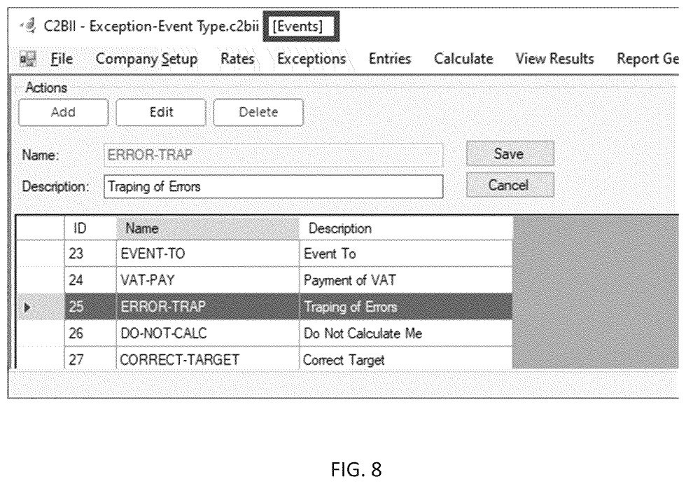

FIG. 8 illustrates an example graphical user interface (display window) that can be presented as part of block 113 of the workflow of FIGS. 1A to 1E to enable a user to specify (e.g., create or edit) data representing one or more event types. One example event type (e.g., the error-trap event type) is shown in detail. Note that the event types can include the error-trap event type (which corresponds to events that are excluded from the financial value analysis and potentially require review or evaluation by the user for inclusion) and an ignore event type (which correspond to events that are purposefully excluded from the financial value analysis). The user can specify other event types as desired for the financial value analysis in order to associate (map) event exception drivers to primary entries and/or impact groups for user configuration of the exception processing required for the financial value analysis.

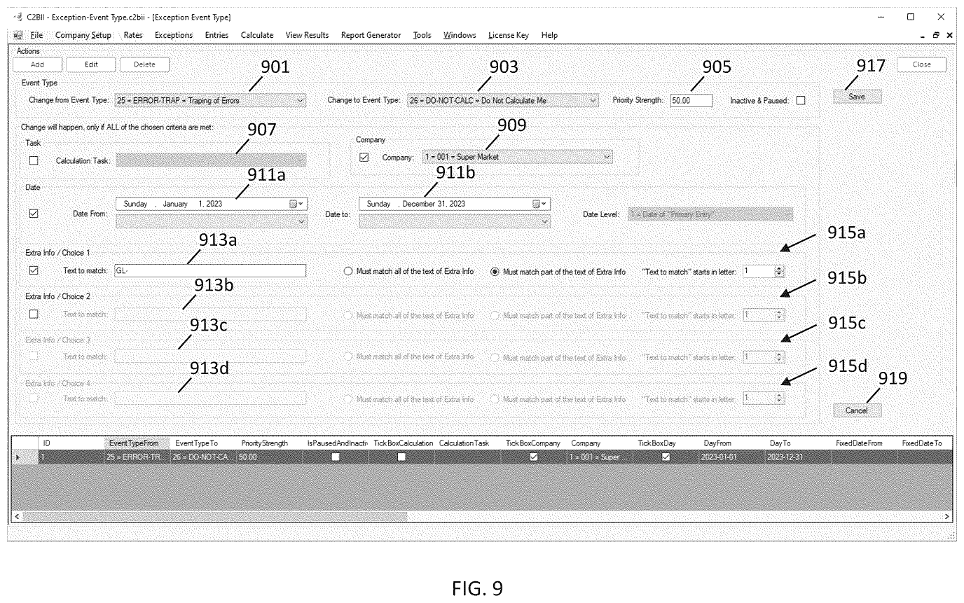

FIG. 9 illustrates an example graphical user interface (display window) that can be presented as part of block 115 of the workflow of FIGS. 1A to 1E to enable a user to specify (e.g., create or edit) data for configuring one or more event exception codes that filters and transforms one or more primary entries from one event type (source event type) to another event type (target event type). The configuration of one example event exception driver is shown in detail. The user can specify the source event type of the event exception code by selecting a particular event type in the drop-down list 901, and the user can specify the target event type of the event exception driver by selecting a particular event type in the drop-down list 903. The user can also assign a priority value (or strength) by entering a value in data box 905. The user can also specify information that is used as matching criteria in the exception processing performed by the event exception driver. In embodiments, such information can include one or more of the following:
a calculation task by selection of the task in drop-down list 907;
a company by selection of the company in drop-down list 909;
a date range between a start date selected or entered in calendar box 911a and an end date selected or entered in calendar box 911b; and
arbitrary text data (e.g., alphanumeric character strings) entered into one or more of four data boxes 913a to 913d; this arbitrary text is used to define matching criteria for comparison and matching to the exception driver fields of the primary entries, and possibly other data structures used in the financial value analysis.

The interface can also include input boxes 915a to 915d (or other input widgets or mechanisms) that correspond to the text-input data boxes 913a to 913d. These input boxes 915a to 915d allow the user to specify constraints on the matching criteria related to the corresponding text boxes (for example, matching all or part of the arbitrary text and the starting position required in matching the arbitrary text to an exception driver field or part thereof. The user can save the input by selecting the save button 917 or cancel the input by selecting the cancel button 919.

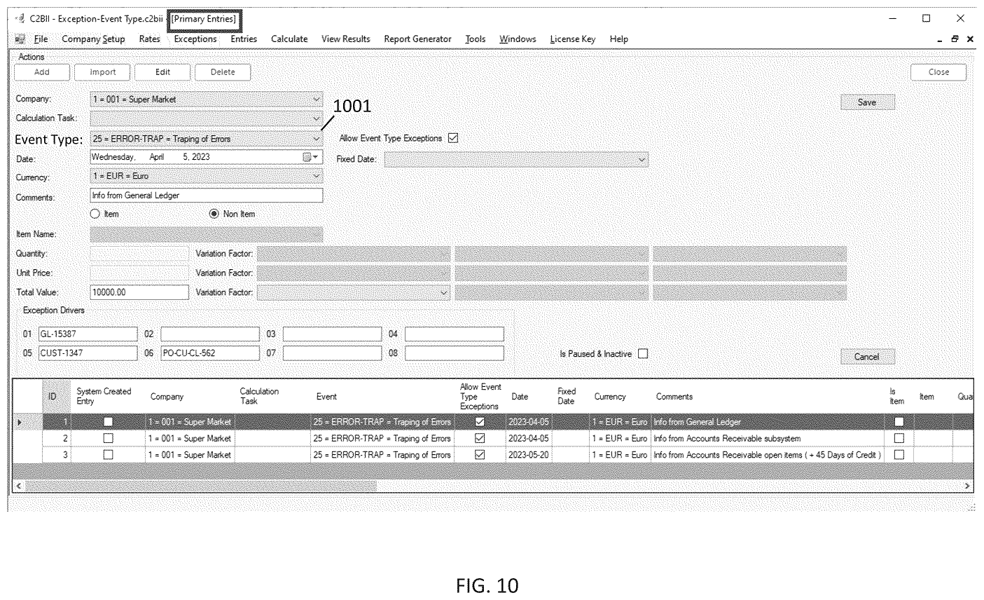

Note that the event exception codes (block 115 and FIG. 9) can be associated with (or mapped to) particular event types under user control. For example, this can involve the user specifying the source event type and target event type of the event exception code (FIG. 9). Furthermore, one or more primary entries and impact groups can be associated with (or mapped to) particular event types under user control. For example, this can involve the user specifying the event type associated with a particular primary entry or impact group, e.g., by user selection of event type in drop-down list 1001 for a primary entry as shown in FIG. 10. This user-controlled association/mapping provides the user with flexibility in associating or linking primary entries to impact groups for use in the financial value analysis. Furthermore, this user-controlled association/mapping enables a user-defined event exception code to selectively filter and apply an impact group that is configured to distribute the actual or forecasted incidents of the primary entries that match the user-defined event exception code as part of the financial value analysis. The distribution flows as debits or credits to predefined accounts as dictated by the associated impact group associated with the matching primary entry.

During the exception processing of block 123, the matching criteria of each active event type exception code can be evaluated and compared to the date, company, calculation task, and user-defined text of the exception driver fields of the respective primary entries, as well as other information that is included in the primary entry and/or in an impact group. Specifically, the date range specified by the matching criteria of the event type exception driver can be compared to the date of a respective primary entry, where such date choice is described as Date Level 1; the company specified by the matching criteria of the event type exception code can be compared to the company of a respective primary entry; the computation task specified by the matching criteria of the event type exception code can be compared to the computation task of a respective primary entry; and the text-based matching criteria of the event type exception code can be compared to user-defined text of the exception driver fields of a respective primary entry. If all matching criteria of the event-type exception code that were defined as needed to be evaluated (FIG. 9) is fully satisfied by a given primary entry and such primary entry is associated with the source event type of the matching event type exception code, the primary entry can be transformed by associating the target event type to primary entry. However, if the matching criteria of the event type exception code is not fully satisfied for a given primary entry and/or such primary entry is not associated with the source event type of a matching event type exception code, the primary entry will not be transformed by the event type exception code. In this manner, the exception processing can be configured to selectively apply the target event type of an event type exception code to a primary entry that matches the matching criteria of the event type exception code when the primary entry is associated with the source event type of the event type exception code.

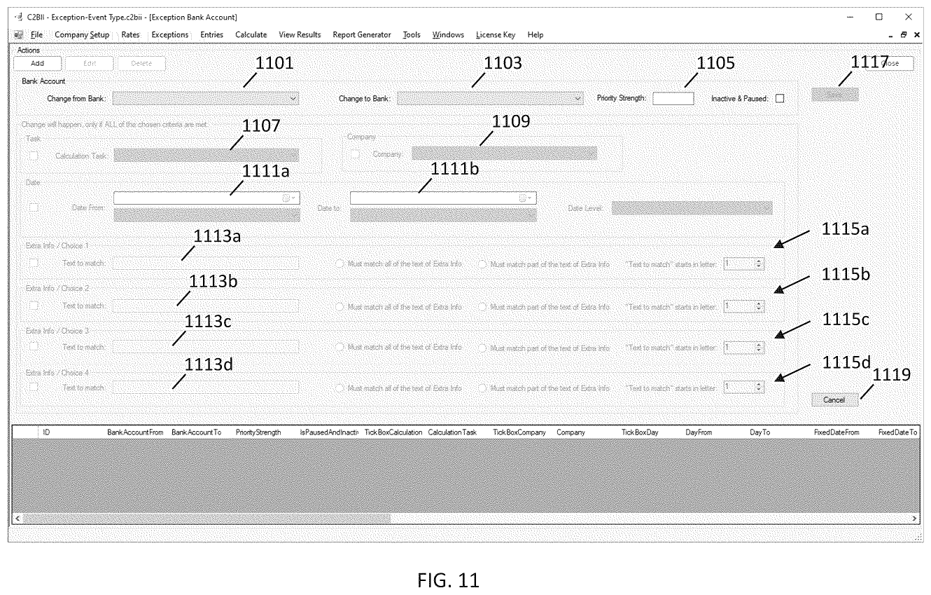

FIG. 11 illustrates an example graphical user interface (display window) that can be presented as part of block 117 of the workflow of FIGS. 1A to 1E to enable a user to specify (e.g., create or edit) data for configuring one or more bank account exception codes that filters and transforms one bank account identifier (source bank account identifier) to another bank account identifier (target bank account identifier). The configuration of one example bank account exception code is shown in detail. The user can specify the source bank account of the bank account exception code by selecting a particular bank account in the drop-down list 1101, and the user can specify the target bank account of the bank account exception code by selecting a particular bank account in the drop-down list 1103. The user can also assign a priority value (or strength) by entering a value in data box 1105. The user can also specify information that is used as matching criteria in the exception processing performed by the bank account exception driver. In embodiments, such information can include one or more of the following:
a calculation task by selection of the task in drop-down list 1107;
a company by selection of the company in drop-down list 1109;
a date range between a start date selected or entered in calendar box 1111a and an end date selected or entered in calendar box 1111b; and
arbitrary text data (e.g., alphanumeric character strings) entered into one or more of four data boxes 1113a to 1113d; this arbitrary text is used to define text-based matching criteria for comparison and matching to the exception driver fields of the primary entries, impact groups, CCFs and possibly other data structures used in the financial value analysis.

The interface can also include input boxes 1115a to 1115d (or other input widgets or mechanisms) that correspond to the text-input data boxes 1113a to 1113d. These input boxes 1115a to 1115d allow the user to specify constraints on the text-based matching criteria related to the corresponding text boxes (for example, matching all or part of the arbitrary text and the starting position required in matching the arbitrary text to an exception driver field or part thereof. The user can save the input by selecting the save button 1117 or cancel the input by selecting the cancel button 1119.

During the exception processing of block 123, the matching criteria of each active bank account exception code can be evaluated and compared to the date, company, calculation task, and user-defined text of the exception driver fields of the respective impact groups, as well as other information that is included in the primary entry and/or in an impact group. Specifically, the date range specified by the matching criteria of the bank account exception driver can be compared to the date of the respective primary entry, or the date of the analytical line of an impact group (either before or after the implementation of the rule-to find-date) where such date choice is described as Date Level 1 or 2 or 3, in that particular order, as mentioned above; the company specified by the matching criteria of the bank account exception code can be compared to the company of a respective impact group, as such information is inherited by its respective primary entry, or by other means (for example: a company override mechanism); the computation task specified by the matching criteria of the bank account exception code can be compared to the computation task of a respective impact group (as such information is inherited by its respective primary entry, or by other means); and the text-based matching criteria of the active bank account exception code is compared to user-defined text of the exception driver fields (09 to 12—FIG. 5) of a respective impact group and those inherited by the respective primary entry (01 to 08—FIG. 4); and If all matching criteria of the bank account exception code that were defined as needed to be evaluated (FIG. 11) is fully satisfied by a given impact group and such impact group refers to the source bank account (identified by the source bank account identifier of the matching bank account exception code), the impact group can be transformed by applying the target bank account (identified by the target bank account identifier of the matching bank account exception code) to such impact group. However, if the matching criteria of a bank account exception code is not fully satisfied for a given impact group and/or such impact group does not refer to the source bank account, the impact group will not be transformed by the bank account driver exception code. In this manner, the exception processing can be configured to selectively apply the target bank account of a bank account exception code to an impact group that matches the matching criteria of the bank account exception code when the impact group refers to the source bank account of the bank account exception code.

FIG. 12 illustrates an example graphical user interface (display window) that can be presented as part of block 119 of the workflow of FIGS. 1A to 1E to enable a user to specify (e.g., create or edit) data for configuring one or more CCF exception codes that filters and transforms one CCF identifier (source CCF identifier) to another CCF identifier (target CCF identifier). The configuration of one example CCF exception code is shown in detail. The user can specify the source CCF identifier of the CCF exception code by selecting a particular CCF/CCF identifier in the drop-down list 1201, and the user can specify the target CCF identifier of the CCF exception code by selecting a particular CCF/CCF identifier in the drop-down list 1203. The user can also assign a priority value (or strength) by entry of the value in data box 1205. The user can also specify information that is used as matching criteria in the exception processing performed by the CCF exception code. In embodiments, such information can include one or more of the following:
a calculation task by selection of the task in drop-down list 1207;
a company by selection of the company in drop-down list 1209;
a date range between a start date selected or entered in calendar box 1211a and an end date selected or entered in calendar box 1211b; and
arbitrary text data (e.g., alphanumeric character strings) entered into one or more of four data boxes 1213a to 1213d; this arbitrary text is used to define matching criteria for comparison and matching to the exception driver fields of the primary entries, impact groups, CCFs and possibly other data structures used in the financial value analysis.
   The interface can also include input boxes 1215a to 1215d (or other input widgets or mechanisms) that correspond to the text-input data boxes 1213a to 1213d. These input boxes 1215a to 1215d allow the user to specify constraints on the matching criteria related to the corresponding text boxes (for example, matching all or part of the arbitrary text and the starting position required in matching the arbitrary text to an exception driver field or part thereof. The user can save the input by selecting the save button 1217 or cancel the input by selecting the cancel button 1219.

During the exception processing of block 123, the matching criteria of each active CCF exception code can be evaluated and compared to the date, company, calculation task, and user-defined text of the exception driver fields of the respective impact groups as well as other information that is included in the primary entry and/or in an impact group. Specifically, the date range specified by the matching criteria of the CCF exception driver can be compared to the date of the respective primary entry, or the date of the analytical line of an impact group, either before or after the implementation of the rule-to find-date (where such date choice is described as Date Level 1 or 2 or 3, in that particular order, as mentioned above); the company specified by the matching criteria of the CCF exception code can be compared to the company of a respective impact group (as such information is inherited by its respective primary entry, or by other means); the computation task specified by the matching criteria of the CCF exception driver can be compared to the computation task of a respective impact group (as such information is inherited by its respective primary entry, or by other means); and the text-based matching criteria of the CCF exception code can be compared to the user-defined text of the exception driver fields (09 to 12—FIG. 5) of a respective impact group, the CCF's own exception driver fields (13 to 16—FIG. 6) and its own CCF Group code's (if such an association has been defined) exception driver fields (17 to 20—FIGS. 7 and 6), and those inherited by the respective primary entry (01 to 08—FIG. 4). If all matching criteria of the CCF exception code that were defined as needed to be evaluated (FIG. 12) is fully satisfied by a given impact group and such impact group refers to the source CCF (identified by the source CCF identifier of the matching CCF exception code), the impact group can be transformed by applying the target CCF (identified by the target CCF identifier of the matching CCF exception code) to such impact group. However, if the matching criteria of a CCF exception code is not fully satisfied for a given impact group and/or such impact group does not refer to the source CCF, the impact group will not be transformed by the CCF exception code. In this manner, the exception processing can be configured to selectively apply the target CCF of a CCF exception code to an impact group that matches the matching criteria of the CCF exception code when the impact group refers to the source CCF of the CCF exception code.

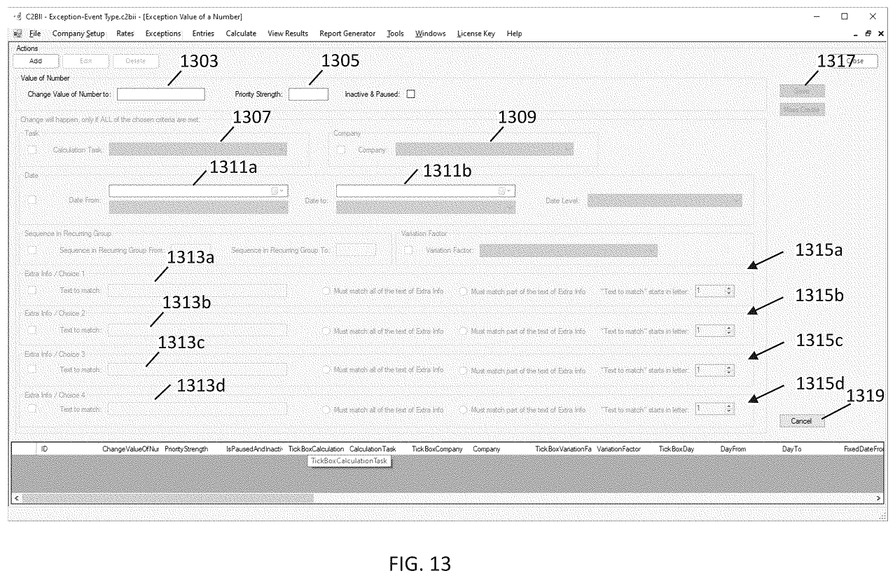

FIG. 13 illustrates an example graphical user interface (display window) that can be presented as part of block 121 of the workflow of FIGS. 1A to 1E to enable a user to specify (e.g., create or edit) data for configuring one or more value of number exception codes that filters and transforms any number value to another number value (target number value). The configuration of one example value of number exception code is shown in detail. The user can specify the target number value of the value of number exception code by entering a value in the data box 1303. The user can also assign a priority value (or strength) by entering a value in data box 1305. The user can also specify information that is used as matching criteria in the exception processing performed by the value of a number exception code. In embodiments, such information can include one or more of the following:
a calculation task by selection of the task in drop-down list 1307;
a company by selection of the company in drop-down list 1309;
a date range between a start date selected or entered in calendar box 1311a and an end date selected or entered in calendar box 1311b; and
arbitrary text data (e.g., alphanumeric character strings) entered into one or more of four data boxes 1313a to 1313d; this arbitrary text is used to define matching criteria for comparison and matching to the exception driver fields of the primary entries, impact groups, CCFs and possibly other data structures used in the financial value analysis.

The interface can also include input boxes 1315a to 1315d (or other input widgets or mechanisms) that correspond to the text-input data boxes 1313a to 1313d. These input boxes 1315a to 1315d allow the user to specify constraints on the matching criteria related to the corresponding text boxes (for example, matching all or part of the arbitrary text and the starting position required in matching the arbitrary text to an exception driver field or part thereof. The user can save the input by selecting the save button 1317 or cancel the input by selecting the cancel button 1319.

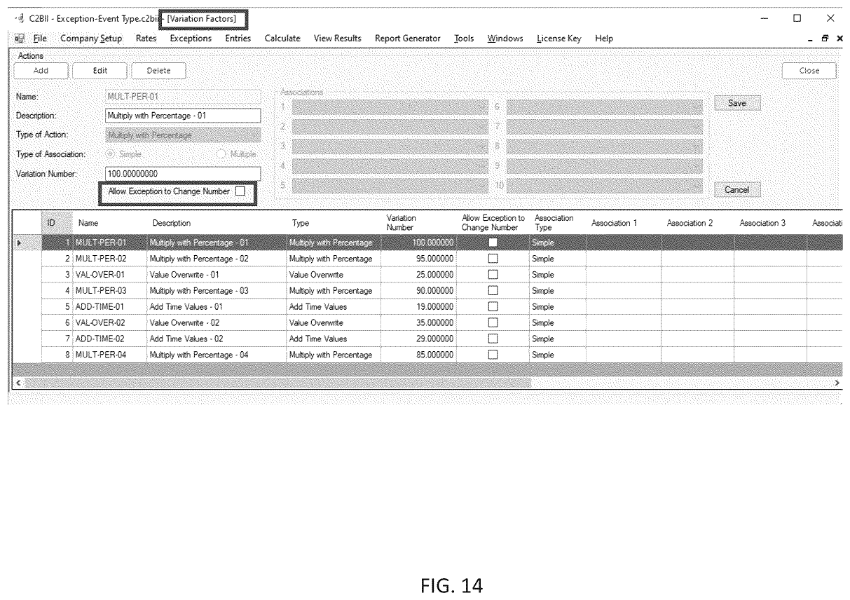

In embodiments, the value of a number exception code can be used to selectively transform the value of a variation factor that is part of a primary entry or impact group (or any other data structure) during the financial value analysis. The transformation of the variation factors can be used for investigating possible scenarios and/or situations (e.g., what-if scenarios) in conjunction with the financial value analysis, and/or the composition of the calculation method of some numerical value in conjunction with the financial value analysis. An example is shown in FIG. 14. In this case, the user configuration potentially associates the transformation of a variation factor to a particular calculation task field that links a set of predefined operations for a user-defined time period to a company (or group of companies) for use in the financial value analysis of block 123. In this manner, the user can configure one or more calculation tasks that utilize different variation factors for different what-if scenarios. For example, calculating “Interest Expense” with a rate of 8% in one scenario, and calculating “Interest Expense” with a rate of 5% in another scenario (that is identical to the first, in all other aspects) to account for variability in interest rates.

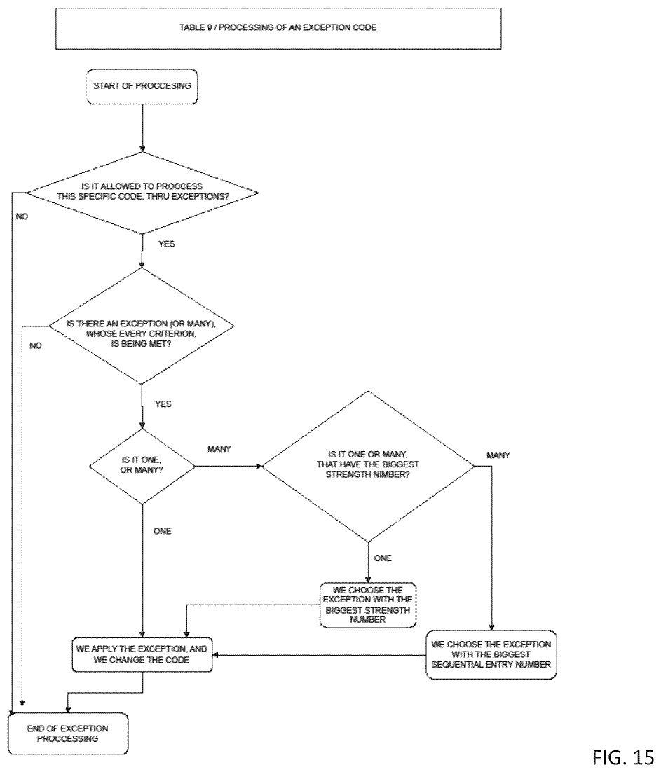

In configuring and processing the exception drivers as configured by the user, there may be instances where the matching criteria for more than one exception code is satisfied but only one matching exception code should be applied to the data item. To help resolve this issue, the user can associate priority (or strength) values with the exception codes, and the exception processing can be configured to identify instances where a given data item satisfies the matching criteria for more than one exception codes. When such an instance is identified, the exception processing can select to use the exception code with the highest priority (or strength) as assigned by the user (if there is only one with highest priority), or select the exception driver based on another data value (such as most recent sequential entry number) if there is more than one matching exception driver with highest priority/strength. FIG. 15 illustrates an embodiment of exemplary exception processing that follows these operations.

### Primary Entries, Impact Groups, and Analytical Lines

The financial value analysis of block 123 employs primary entries, impact groups, and optional CCFs to calculate analytical lines for accounts of an entity or business over time where the accounts simulate the accounting records of the entity or business over time.

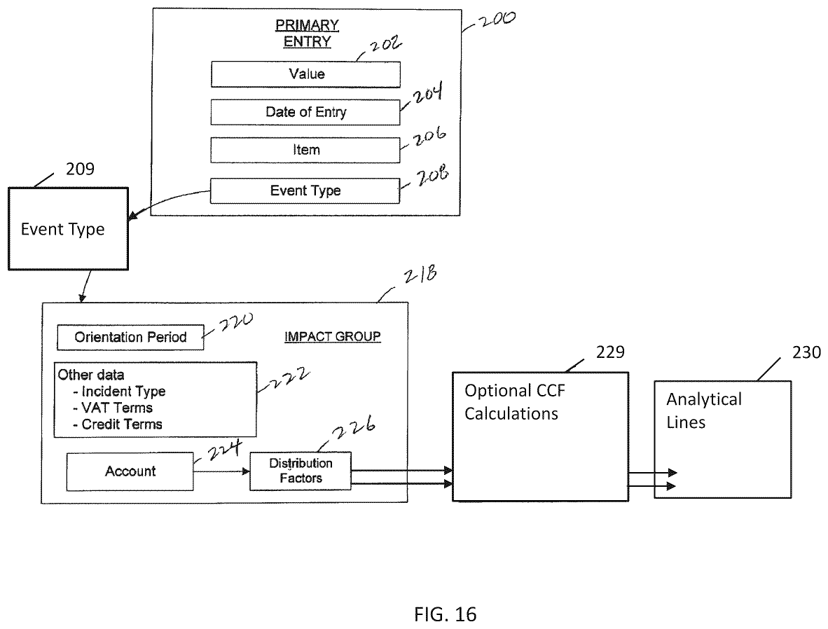

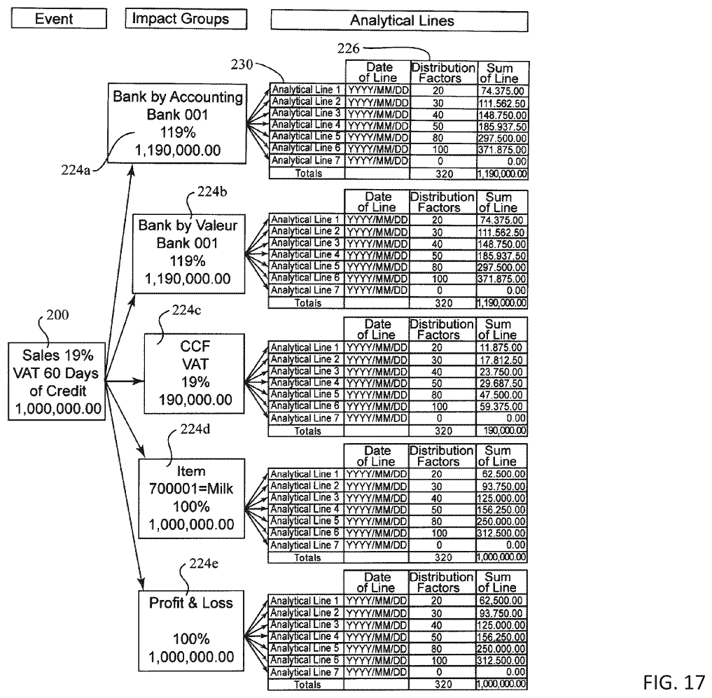

As depicted by the schematic diagram of FIG. 16, a primary entry 200 is a data structure that includes a value 202, a date 204, an item identifier 206, and an event type 208. The value 202 represents a monetary value for the primary entry 200 and it can be defined by a single data field or by a calculation of multiple data fields (such as unit price #of units sold). The date 204 (and the orientation period of the associated impact group defines a time period over which the value 202 of the primary entry 200 is to be allocated. The item identifier 206 identifies one or more items associated with the primary entry 200 and can be employed to associate one or more accounts to the primary entry 200. The event type 208 is a label or key that refers to the event type 209. In this manner, the event type 209 can be shared across multiple primary entries that are similar to one another. The event type 209 associates the primary entry 200 with one or more impact groups 218 as described below. The primary entry 200 can include other data (such as currency type) that is used to characterize the financial incident represented by the primary entry 200. The other data can also include an identifier for the company associated with the primary entry, comments, etc.

The impact group 218 is a data structure that includes an orientation period 220 (e.g., year, month, week, quarter, etc.), other data 222, an account 224, and a set of distribution factors 226. The date 204 of the primary entry 200 associated with the impact group 218 (by event type 208) and the orientation period 220 of the impact group 218 defines a time period over which the value 202 of the primary entry 200 is to be allocated as will be described below. The distribution factors 226 of the impact group 218 includes one or more distribution factors that dictate the allocation of the value 202 of the primary entry 200 associated with impact group for the account 222 over this time period as described below in more detail.

The impact group 218 can also include other data 222, such as one or more of the following:
data values (e.g., incident type, VAT Terms, Credit Terms) used to derive the analytical lines for the primary entry and impact group;
a percentage value which dictates a percentage of the value 202 of the associated primary entry to allocate over the account 224 of the impact group in accordance with the distribution factors 226 and the time period defined by the date 204 and orientation period 220 of the associated primary entry;
an impact group type (e.g., income/sale type or expense/purchase type—these types can be used to select or derive an appropriate currency exchange rate if the monies are to be paid or collected in a foreign currency);
an event type, which is used to link the impact group to one or more primary entries and to one or more event exception drivers as described herein;
parameters for CCF calculations; and
parameters for rules-to-find-date calculations.

As part of block 123, the exception codes of 115 to 121 can be used to filter and transform primary entries and associated impact groups and optional CCF calculations, or parts thereof as described herein. The primary entries and impact groups and optional CCF calculations that result from the exception processing can be used in the financial value analysis of block 123 to generate a simulation of the accounting books of the financial entity or business (or part thereof) over time. The simulation results can be processed to determine a value of the actual and/or forecasted financial incidents based on the simulation results. The value derived from the simulation results can be used as a tool in making decisions about activities such as funding, capital expenditure and investment in the entity or business (or part thereof).

As part of the financial value analysis of block 123, the primary entries and associated impact groups and optional CCFs that result from the filtering and transformation of the exception processing can be used to define analytical lines for the accounts of the impact groups and optional CCFs as shown. The analytical lines are defined by a date as well as a portion of the primary entry value as dictated by the optional percentage value and distribution factor for such date as represented by the impact group. The analytical lines for the accounts represent debits or credits to the accounts over time. The analytical lines can be grouped together to simulate the accounting books of the financial entity or business (or part thereof) over time. The grouping of analytical lines into the appropriate accounts is dictated by the account of the impact group from which the respective analytical line was derived.

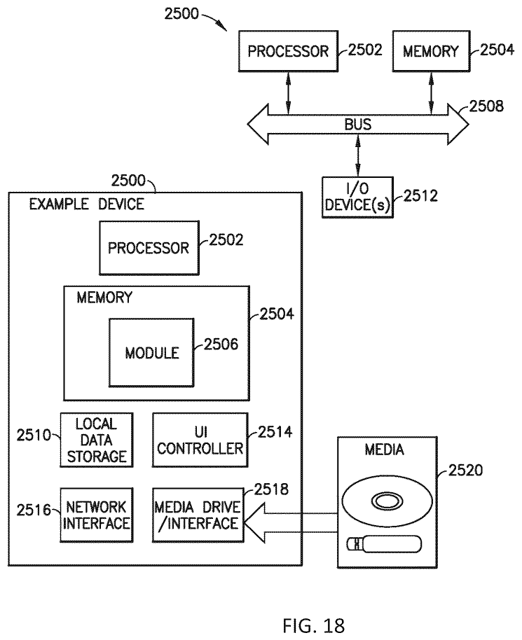

For example, consider a primary entry 200 for a supermarket store that includes a value 202 of $1,000,000 and a date of entry 204 of Jul. 15, 2008, all related to the weekly sales of an item milk as shown in FIG. 18. Other data 210 includes a “sale” incident type 204, VAT Terms of 19% and Credit Terms of 60 days credit. The event type 208 is associated with an impact group 218 having an orientation period 220 of a week. The association of the primary entry 200 to the impact group 218 can be dictated by user input (or possibly by automatic means). The associated impact group 218 may differ depending on the various data values of the primary entry 200. For example, for a sale type event with VAT and credit terms, such sale occurring over one week, five impact groups 218 for the following accounts can be associated therewith: (i) bank by accounting, (ii) bank by valeur, (iii) calculated cash flow (CCF), (iv) item, and (v) profits and loss, each with an orientation period of a week.

As part of the financial value analysis of block 123, the simulation of the accounting books of the entity or company (or part thereof) over time can be processed to determine a value of the actual or forecasted financial incidents represented by relevant primary entries. More specifically, financial inflows over time can be calculated from increases in the accounts related to income over time (or decreases in the accounts related to expenses over time), while financial outflows over time can be calculated from decreases in the accounts related to income over time (or increases in the accounts related to expenses over time). In one example, the simulated accounting books can be processed to calculate profit (or loss) over time. Profit can be calculated for the case that income exceeds expenses. Loss can be calculated for the case that expenses exceed income. Financial inflows over time can be calculated from increases in profit over time or decreases in loss over time. Financial outflows over time can be calculated from decreases in profit over time or increases in loss over time. A net present value can be calculated from the financial inflows over time and the financial outflows over time. The net present value represents a value of the actual or forecasted financial incidents represented by the relevant primary entries. and impact groups and optional Banks or Items or CCFs that result from the exception processing configured by the user-defined exception drivers.

In the methodology described herein, it is contemplated that the initial set of primary entries ingested into the program will be assigned a default error-trap event type (or another chosen event type, that is deemed to be relevant in a specific situation), and the user will interact with the graphical user interfaces of the program to configure a small set of event type exception codes that convert the default error-trap event type of the primary entries to an appropriate event type, that is associated with impact groups and optional Banks or Items or CCFs that are configured to distribute the value of the filtered and transformed primaries entries to appropriate accounts over time in manner that simulates the accounting books of the financial entity or business (or part thereof) over time.

The user can also interact with the graphical user interfaces of the program to configure a small set of event type exception codes that convert the default error-trap event type (or any chosen relevant event type) of the primary entries to an ignore (i.e., do-not-calculate) event type for primary entries that should be ignored (not used) in the financial value analysis.

Before or after performing the financial value analysis, the user can possibly review and evaluate the primary entries that belong to the error-trap event type and/or the primary entries that belong to the ignore event type to evaluate possible errors and omissions with respect primary entries that are accounted for (or not included) in the financial value analysis. All of the above-mentioned data (primary entries, exception codes etc.), in all of the paragraphs of the description of this invention, can either be imported to this system, in their entirety from an external information structure (like an ERP and/or a Budgeting module and/or a Business Intelligence suite and/or an Artificial Intelligence application and/or a Project Management application etc.), or they can be manually entered in their entirety by a user, or they can come from any combination of the above mentioned sources (for example: part imported and part manual data entry).

In the methodology described herein, the exception driver text data that is associated with primary entries, impact groups, CCFs and other data structures can be derived from context of the relevant data in the financial accounting system (like an ERP and/or a Budgeting module and/or a Business Intelligence suite and/or an Artificial Intelligence application and/or a Project Management application etc.), that is the source of the data.

For example, the exception driver text data can include a serial number of an entry in the financial accounting system (e.g., in Accounts Payable, or in Accounts Receivable, or in securities, or in General Accounting, etc.), possibly with the use of an appropriate prefix.

In another example, the exception driver text data can include a code used in the financial accounting system (e.g., in Accounts Payable, or in Accounts Receivable), possibly using an appropriate prefix. For example: in an Accounts Receivable subsystem that refers to the customer code 4127, the text “CUST-4127” may be used as part of the exception driver text data.

In yet another example, the exception driver text data can include a code of a general ledger account, which refers to its (analytical or aggregated daily or monthly or any other length of period) movement, possibly with the use of an appropriate prefix. For example: in an entry that refers to the General Ledger account code “62.07.03”, the text “ACC-62.07.03” may be used as part of the exception driver text data.

In still another example, the exception driver text data can include a serial number of a purchase or sales order as well as the code of the subsystem (Accounts Payable or Accounts Receivable) to which the order refers, possibly using an appropriate prefix. Also, in another “Exception Driver”, there may be some text, which refers to the information, if this order is open, or if it has been processed.

In yet another example, the exception driver text data can include an invoice number used as part of Accounts Payable or Accounts Receivable subsystems, possibly using an appropriate prefix.

In another example, the exception driver text data can include descriptive text (such “Travel Expenses” or “Sales of XYZ Product Family”).

In yet another example, the exception driver text data can be based on an item code (SKU), quantity, price, and relevant date of goods and/or materials.

FIG. 18 illustrates an example device 2500, with a processor 2502 and memory 2504 that can be configured to implement various embodiments of the methods and processes as discussed in the present application. Memory 2504 can also host one or more databases and can include one or more forms of volatile data storage media such as random-access memory (RAM), and/or one or more forms of non-volatile storage media (such as read-only memory (ROM), flash memory, and so forth).

Device 2500 is one example of a computing device or programmable device and is not intended to suggest any limitation as to scope of use or functionality of device 2500 and/or its possible architectures. For example, device 2500 can comprise one or more computing devices, programmable logic controllers (PLCs), etc.

Further, device 2500 should not be interpreted as having any dependency relating to one or a combination of components illustrated in device 2500. For example, device 2500 may include one or more of computers, such as a laptop computer, a desktop computer, a mainframe computer, etc., or any combination or accumulation thereof.

Device 2500 can also include a bus 2508 configured to allow various components and devices, such as processors 2502, memory 2504, and local data storage 2510, among other components, to communicate with each other.

Bus 2508 can include one or more of any of several types of bus structures, including a memory bus or memory controller, a peripheral bus, an accelerated graphics port, and a processor or local bus using any of a variety of bus architectures. Bus 2508 can also include wired and/or wireless buses.

Local data storage 2510 can include fixed media (e.g., RAM, ROM, a fixed hard drive, etc.) as well as removable media (e.g., a flash memory drive, a removable hard drive, optical disks, magnetic disks, and so forth). One or more input/output (I/O) device(s) 2512 may also communicate via a user interface (UI) controller 2514, which may connect with I/O device(s) 2512 either directly or through bus 2508.

In one possible implementation, a network interface 2516 may communicate outside of device 2500 via a connected network. A media drive/interface 2518 can accept removable tangible media 2520, such as flash drives, optical disks, removable hard drives, software products, etc. In one possible implementation, logic, computing instructions, and/or software programs comprising elements of module 2506 may reside on removable media 2520 readable by media drive/interface 2518.

In one possible embodiment, input/output device(s) 2512 can allow a user (such as a human annotator) to enter commands and information to device 2500, and also allow information to be presented to the user and/or other components or devices. Examples of input device(s) 2512 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various systems and processes of present disclosure may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable, and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer. Some of the methods and processes described above, can be performed by a processor. The term “processor” should not be construed to limit the embodiments disclosed herein to any particular device type or system. The processor may include a computer system. The computer system may also include a computer processor (e.g., a microprocessor, microcontroller, digital signal processor, general-purpose computer, special-purpose machine, virtual machine, software container, or appliance) for executing any of the methods and processes described above.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Some of the methods and processes described above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web), or executed by one or more processors (e.g., physical machines or virtual machines) that operate in a cloud computing environment (e.g., AWS or Azure or other cloud computing environment) and accessed by users through execution of web-browsers, or application(s) or other program code on user devices that connect to the cloud computing environment using data communication over the Internet.

Although only a few example embodiments have been described in detail above, those skilled in the art will readily appreciate that many modifications are possible in the example embodiments without materially departing from this invention.

Accordingly, all such modifications are intended to be included within the scope of this disclosure as defined in the following claims. In the claims, means-plus-function clauses are intended to cover the structures described herein as performing the recited function and not only structural equivalents, but also equivalent structures.

There have been described and illustrated herein several embodiments of a computer-implemented method involving financial value analysis. While particular embodiments of the invention have been described, it is not intended that the invention be limited thereto, as it is intended that the invention be as broad in scope as the art will allow and that the specification be read likewise. Thus, while particular data structures and formulaic expressions have been disclosed, it will be appreciated that other data structures can be used as well. In addition, while particular calculations have been disclosed for determining particular accounting records (such as costs of goods sold, gross profits, taxable income, net income, etc.), it will be understood that other calculations can be used. Also, while particular calculations have been disclosed for discounting actual or forecasted financial values to a net present value, it will be recognized that other discounting-type calculations can be used as well. It will therefore be appreciated by those skilled in the art that yet other modifications could be made to the provided invention without deviating from its spirit and scope as claimed.

What is claimed is:

1. A computer-implemented method carried out by a computer processing system for financial analysis of a business entity, the method comprising:
i) loading input data output from an external financial system, wherein at least part of the input data relates to actual or forecasted financial incidents of the business entity, and processing the input data to generate and store an initial set of primary entries based on the input data, wherein the initial set of primary entries represent actual and/or forecasted financial incidents of the business entity;
ii) interacting with a user to specify data representing at least one event type and at least one impact group, wherein a given event type can be associated with at least one primary entry and at least one impact group to define an association or link therebetween, and wherein a given impact group includes data that references an account and a set of distribution factors used to distribute value of a primary entry associated with the given impact group (or a percentage thereof) to the referenced account over time;
iii) interacting with the user to specify data representing at least one exception code that is configured to filter and transform at least the initial set of primary entries;
iv) using the at least one exception code to filter and transform at least the initial set of primary entries to generate and store primary entries and associated event types and impact groups based on the input data; and
v) using the primary entries and the associated event types and impact groups that result from the filtering and transformation of iv) in performing financial value analysis that generates a simulation of the accounting books of the financial entity or business (or part thereof) over time and determines a value of the actual and/or forecasted financial incidents of the business entity based on the simulation.

2. A computer-implemented method according to claim 1, further comprising:
the user using the value of the actual and/or forecasted financial incidents of the business entity as a tool in making decisions about activities, such as funding, capital expenditure or investment in the business entity (or part thereof).

3. A computer-implemented method according to claim 1, wherein:
the at least one exception code is configured by user interaction with at least one graphical user interface presented to the user.

4. A computer-implemented method according to claim 1, wherein:
the at least one exception code is used in conjunction with a software-implemented data handler that employs text data and/or date data as part of matching criteria, wherein the matching criteria is used to selectively apply exception processing that dynamically filters and transforms data to generate and store primary entries and associated impact groups and optional CCF calculations based on the input data.

5. A computer-implemented method according to claim 4, wherein:
the at least one exception code is configured to generate a first set of primary entries and associated impact groups and optional CCF calculations that are based on the input data and relevant to the financial value analysis of v); and
the at least one exception code is configured to generate a second set of primary entries and associated impact groups and optional CCF calculations that are based on the input data but excluded or irrelevant to the financial value analysis of v).

6. A computer-implemented method according to claim 4, wherein:
as part of the financial value analysis of v), impact groups and associated CCF calculations that result from the filtering and transformation of iv) generate analytical lines that represent debits or credits to specific accounts over time, where the analytical lines are grouped together to create the accounts that simulate the accounting books of the business entity (or part thereof) over time.

7. A computer-implemented method according to claim 1, wherein:
the at least one exception code comprises at least one event type exception code that filters and transforms at least one primary entry from a source event type to a target event type.

8. A computer-implemented method according to claim 7, wherein:
the at least one event type exception code is configured by the user to perform exception processing that selectively applies the target event type of the event type exception code to a primary entry that matches matching criteria of the event type exception code when the primary entry is associated with the source event type of the event type exception driver.

9. A computer-implemented method according to claim 1, wherein:
the at least one exception code comprises at least one CCF exception code that filters and transforms a source CCF identifier to a target CCF identifier.

10. A computer-implemented method according to claim 9, wherein:
the at least one CCF exception code is configured by the user to perform exception processing that selectively applies target CCF calculations referenced by the CCF exception code to an impact group that matches the matching criteria of the CCF exception code when the impact group refers to the source CCF calculations referenced by the CCF exception code.

11. A computer-implemented method according to claim 1, wherein:
the at least one exception code comprises at least one bank account exception code that filters and transforms a source bank account identifier to a target bank account identifier.

12. A computer-implemented method according to claim 11, wherein:
the at least one bank account exception code is configured by the user to perform exception processing that selectively applies a target bank account referenced by the bank account exception code to an impact group that matches the matching criteria of the bank account exception code when the impact group refers to a source bank account referenced by the bank account exception code.

13. A computer-implemented method according to claim 1, wherein:
the at least one exception code comprises at least one value of number account exception code that filters and transforms a number value to a target number value.

14. A computer-implemented method according to claim 13, wherein:
at least one value of a number exception code is configured to selectively transform the value of a variation factor that is part of a primary entry or impact group.

15. A computer-implemented method according to claim 14, wherein:
the transformation of the variation factor is used to investigate possible scenarios and/or situations (e.g., what-if scenarios) in conjunction with the financial value analysis.

16. A computer-implemented method according to claim 1, wherein:
some or all of the operations are performed by at least one processor.

17. A computer-implemented method according to claim 16, wherein:
the at least one processor comprises a computing device operated by a user; and/or
the at least one processor is part of a cloud computing environment.

18. A program storage device readable by a machine, tangibly embodying a program of instructions executable by the machine to perform method steps for financial analysis of a business entity, said method steps comprising the method of claim 1.
